(19) United States
(12) Patent Application Publication
(10) Pub. No.: US 2008/0075636 A1
(43) Pub. Date: Mar. 27, 2008

(54) Assay Preparation Systems

(75) Inventors: Adam Richard Schilffarth, Cedar Park, TX (US); William R. Deicher, Austin, TX (US); Paul Pempsell, Bedford, TX (US)

Correspondence Address: DAFFER MCDANIEL LLP, P.O. BOX 684908, AUSTIN, TX, 78768, US

(73) Assignee: LUMINEX CORPORATION, Austin, TX (US)

(21) Appl. No.: 11/858,190

(22) Filed: Sep. 20, 2007

Related U.S. Application Data
(60) Provisional application No. 60/826,639, filed on Sep. 22, 2006.

(51) Int. Cl. B01J 19/10; B01J 19/00; G06F 19/00

(52) U.S. Cl. 422/127; 422/129; 700/266

(57) ABSTRACT

A fluid assay preparation system is provided which includes a reusable reaction apparatus and a plurality of fluidic lines coupled to the reusable reaction apparatus. The reusable reaction apparatus includes a process vessel with a tapered floor and the fluidic lines extend into the process vessel a distance less than approximately 1.0 mm from a bottommost surface of the tapered floor. Inner and outer surfaces of the fluidic lines and an inner surface of the process vessel may include one or more materials having a coefficient of friction less than or equal to approximately 0.1 relative to polished steel. The system further includes an assembly of one or more pumps, one or more valves, and control electronics collectively configured to pass reagents to the process vessel. Methods and storage mediums having program instructions configured to prepare fluid assays using such a system are also provided.

### PRIORITY CLAIM

This application claims priority to U.S. Provisional Application No. 60/826,639 filed Sep. 22, 2006.

### BACKGROUND OF THE INVENTION

1. Field of the Invention

This invention generally relates to systems and methods for preparing fluid assays and, more specifically, to automated systems and methods for preparing fluid assays.

2. Description of the Related Art

The following descriptions and examples are not admitted to be prior art by virtue of their inclusion within this section.

Analysis of fluid assays is used for a variety of purposes, including but not limited to biological screenings and environmental assessments. In some cases, a fluid may be processed prior to being analyzed to remove matter which is not of interest or which may conflict with obtaining accurate analysis results. In addition or alternatively, a fluid may be processed prior to being analyzed to offer results of greater sensitivity and/or specificity. Moreover, a fluid may, in some embodiments, be processed prior to being analyzed to convert the fluid into a form that is compatible with a particular analysis method, such as into an assay which is microsphere-based. In any of such cases, the processing of fluid samples is generally conducted manually and, consequently, the benefit of the preparation of a particular assay-type and/or obtaining results of greater sensitivity and/or specificity may, in some cases, be jeopardized by the intrinsic variability of manual processes. Although efforts to automate the preparation of fluid assays have been attempted, such endeavors have met limited success due to difficulty in automating the removal of reagents used to process the sample as well as portions of the sample which are not of interest or which may conflict with obtaining accurate analysis results. Consequently, the automation of preparing fluid assays is a largely unrealized engineering challenge.

### SUMMARY OF THE INVENTION

The following description of various embodiments of systems and methods for preparing fluid assays is not to be construed in any way as limiting the subject matter of the appended claims.

An embodiment of a system for preparing a fluid assay includes a reusable reaction apparatus and a plurality of fluidic lines coupled to the reusable reaction apparatus. The reusable reaction apparatus includes a process vessel with a tapered floor and the fluidic lines extend into the process vessel a distance less than approximately 1.0 mm from a bottommost surface of the tapered floor. The system further includes a reagent pack receiver coupled to the process vessel via the plurality of fluidic lines, wherein the reagent pack receiver is configured to receive a plurality of reagent filled vessels. In addition, the system includes an assembly of one or more pumps, one or more valves, and control electronics collectively configured to separately pass reagents from the reagent filled vessels to the process vessel and further draw fluids out of the process vessel.

An embodiment of a storage medium includes program instructions which are executable by a processor for transporting a first set of reagents from a plurality of reagent filled vessels to a reaction apparatus for preparation of a first assay. The storage medium further includes program instructions executable by a processor for transporting a decontamination solution from the plurality of reagent filled vessels to the reaction apparatus subsequent to the preparation of the first assay. Furthermore, the storage medium includes program instructions executable by a processor for transporting a second set of reagents from the plurality of reagent filled vessels to the reaction apparatus for preparation of a second assay subsequent to transporting the decontamination solution.

### BRIEF DESCRIPTION OF THE DRAWINGS

Other objects and advantages of the invention will become apparent upon reading the following detailed description and upon reference to the accompanying drawings in which:

FIG. 1 illustrates a schematic drawing of an exemplary system configured for preparing a fluid assay;

FIG. 2 illustrates a prospective view of an exemplary system which follows the schematic layout of FIG. 1;

FIG. 3 illustrates a magnified prospective view of the reaction apparatus included in the system depicted in FIG. 2;

FIG. 4 illustrates cross-sectional view of the process vessel of the reaction apparatus depicted in FIG. 3 during a series of process steps for preparing a fluid assay;

FIG. 5 illustrates a magnified prospective view of the reagent pack receiver of the system depicted in FIG. 2 as well as a reagent pack;

FIG. 6 illustrates cross-sectional view of the reagent pack receiver depicted in FIG. 5 with a reagent pack arranged therein and in a variety of positions to portray oscillation of the reagent pack;

FIG. 7 illustrates a flowchart of an exemplary method for preparing a fluid assay;

FIG. 8 illustrates a flowchart of an exemplary method for processing a fluid sample into a form that is compatible with a predetermined assay;

FIG. 9 illustrates a flowchart of an exemplary method for preparing a nucleic acid assay; and

FIG. 10 illustrates a flowchart of an exemplary method for preparing an immunoassay.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

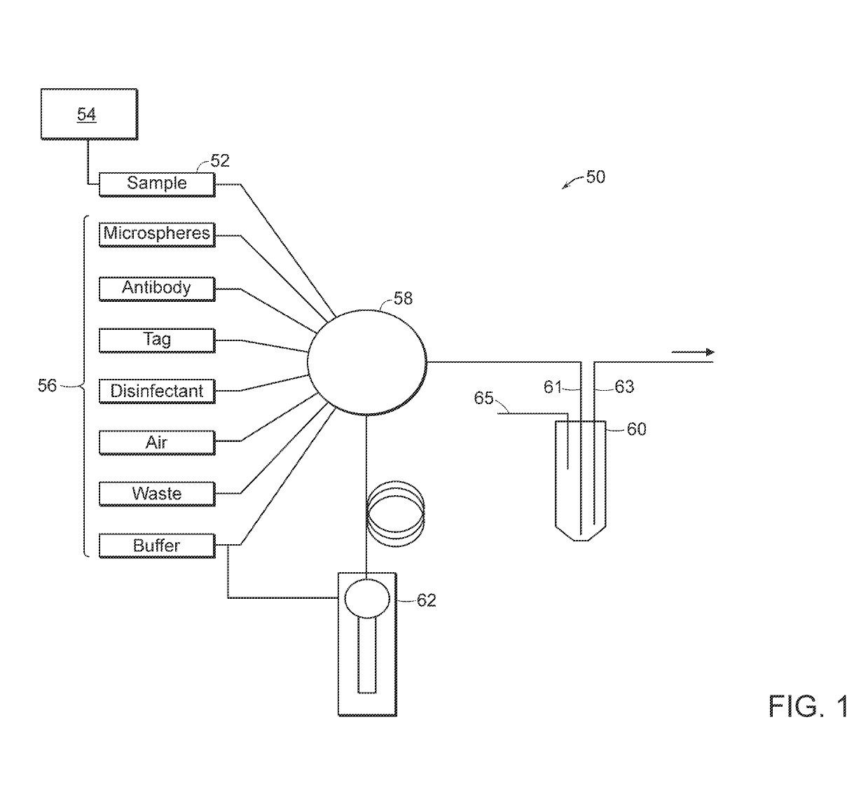

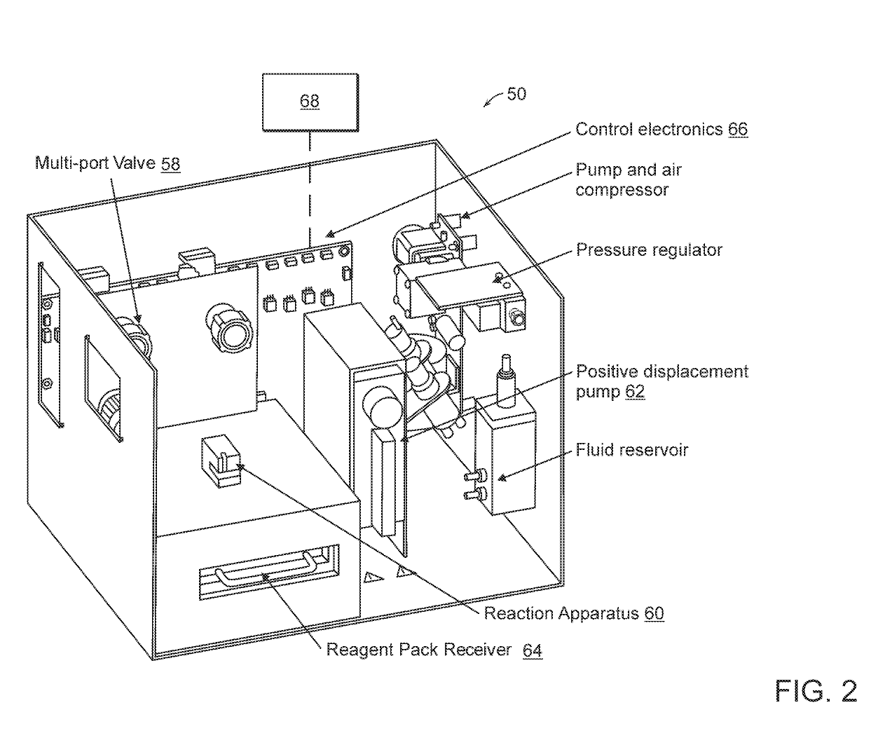

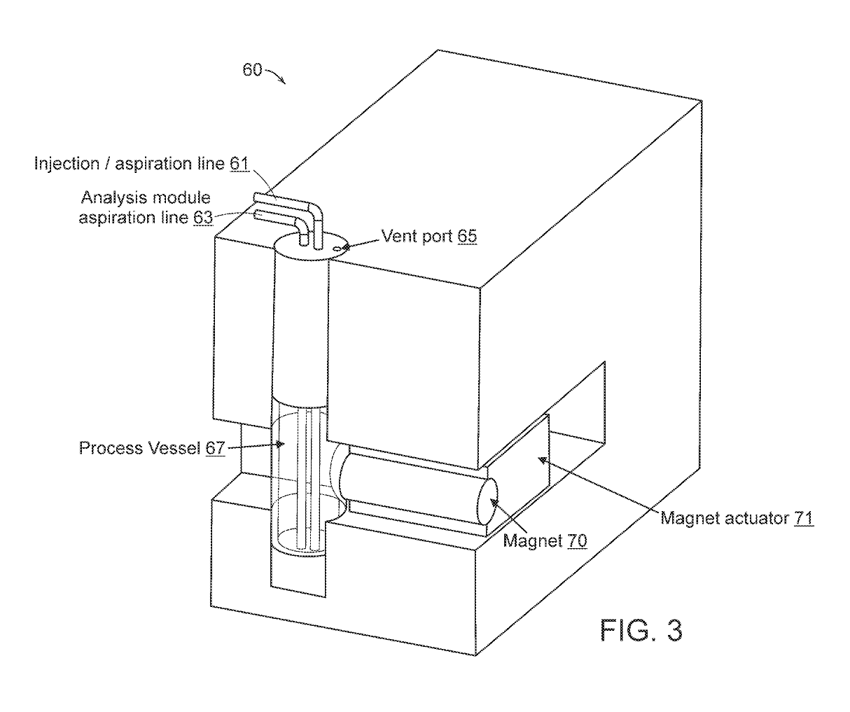

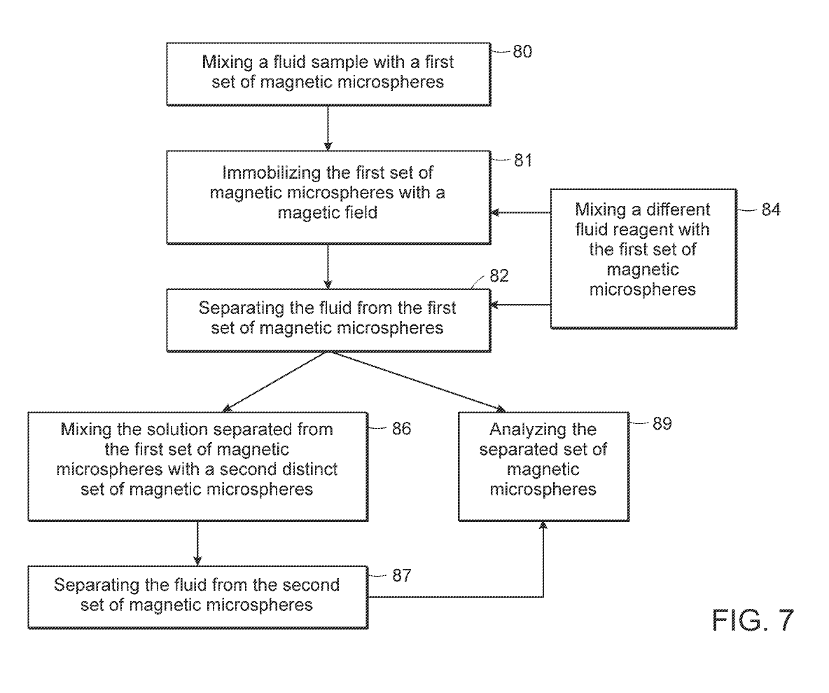

Turning to the drawings, exemplary systems, methods, and program instructions configured for preparing a fluid assay are shown. In particular, an exemplary embodiment of a fluid assay preparation system and components thereof are illustrated in FIGS. 1-6c. In particular, FIG. 1 illustrates a schematic drawing of fluid assay preparation system 50 detailing the flow of fluid through the system. FIG. 2 illustrates a perspective view of an exemplary configuration for fluid assay preparation system 50 detailing the structural and mechanical components of the system. Exemplary components of fluid assay preparation system 50 are illustrated in FIGS. 3-6c. Methods and program instructions configured to prepare fluid assays using such a system are illustrated in the flowcharts of FIGS. 7-10.

As described in more detail below, fluid assay preparation system 50 may be configured to automate sample processing and/or preparations of microsphere based assays. Sample processing is the conversion of a raw sample (i.e., a sample not compatible with a desired assay) into a form that is compatible with a desired assay. Assay preparation takes a converted sample and forms a microsphere based assay. As further described below, fluid assay preparation system 50 may be configured to be reusable. In particular, fluid assay preparation system 50 may be configured such that each of its components may be used repeatedly and, consequently, multiple fluid assays, including those of the same or different makeup, may be prepared using system 50. More specifically, fluid assay preparation system 50 and specific components thereof may be configured such that the system may be sufficiently decontaminated between different assay preparations.

Consequently, in addition to being able to perform the process steps for preparing a fluid assay described in reference to FIGS. 7-10, fluid assay preparation system 50 may include process steps for preparing multiple fluid assays. In particular, fluid assay preparation system 50 may be configured (i.e., include a storage medium with program instructions as described in more detail below) to pass a first set of reagents from the plurality of reagent filled vessels to the process vessel for preparation of a first assay. In addition, fluid assay preparation system 50 may be configured to pass a decontamination solution from the plurality of reagent filled vessels to the process vessel subsequent to preparing of the first assay. In some cases, the first assay may be removed from the process vessel prior introducing the decontamination solution, but in other cases the first assay may be removed along with the decontamination solution. In either case, fluid assay preparation system 50 may be configured to pass a second set of reagents from the plurality of reagent filled vessels to the process vessel for preparation of a second assay subsequent to removing the decontamination solution from the process vessel.

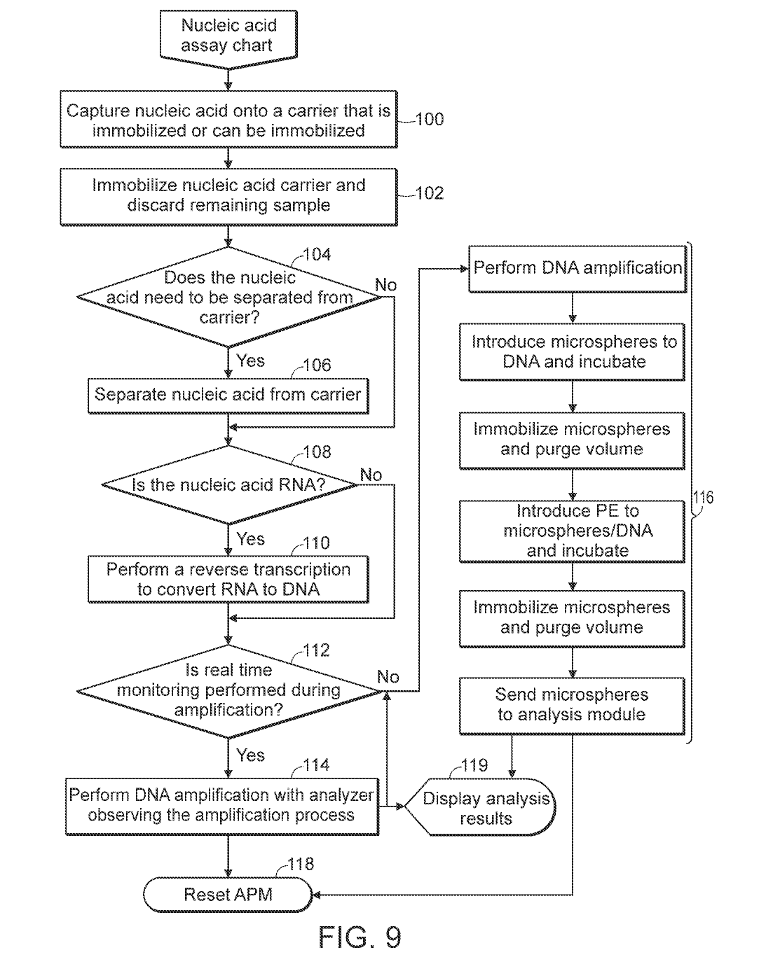

As shown in FIG. 1 (and further shown in FIG. 3 in reference to the magnified view of reaction apparatus 60), fluid assay preparation system 50 may include sample inlet 52 for introducing a fluid sample into system 50. It is noted that input 52 is not shown in FIG. 2 to simplify the drawing, particularly such that the interior components of fluid assay preparation system 50 may be clearly shown. In general, input 52 may be coupled to multiport valve 58 as shown in FIG. 1 and accessible to a user of fluid assay preparation system 50. For example, in some embodiments, input 52 may be incorporated into a lid of fluid assay preparation system 50 or possibly a sidewall. In any case, fluid assay preparation system 50 may be configured to process biological or environmental samples. In some embodiments, fluid assay preparation system 50 may include sample preprocessing system 54 for processing the sample prior to being introduced into inlet 52. The preprocessing system may be configured to perform any of the steps described below in reference to FIG. 9 or any state transformation steps. For example, a wetted wall cyclone may be considered for condensing a gas sample into a liquid.

As shown in FIG. 2, fluid assay preparation system 50 may include reagent pack receiver 64 configured to receive a plurality of reagent filled vessels, such as reagent pack 56 depicted in FIG. 1. In addition to a plurality of vessels each filled with different reagents, reagent pack 56 may also include one or more vessels for receiving waste streams from the fluid assay preparation performed by system 50. In addition or alternatively, reagent pack 56 may include one or more vessels for temporarily storing fluids received from process vessel 67. In particular, a fluid assay preparation process may, in some embodiments, include processing a sample with different sets of magnetic microsphere as discussed in more detail below in reference to FIG. 7. In such cases, it may be necessary to route fluid separated from a first set of magnetic microspheres to a temporary storage vessel within reagent pack 56, subsequently remove the first set of magnetic microspheres from process vessel 67, and then route the fluid from the temporary storage vessel of reagent pack 56 back to process vessel 67 to be mixed with a second distinct set of magnetic microspheres.

In general, reagent pack 56 may be configured for single or multiple use operations. As such, reagent pack 56 may be configured to be disposable (i.e., thrown away after a single fluid assay has been prepared) or may be reusable (i.e., includes a reagent in amounts sufficient to prepare multiple assays). In the latter case, the vessels of reagent pack 56 may be configured to be disposed after one or more of the reagents are consumed or may be configured to be refilled. In either embodiment, reagent pack 56 allows for easy replacement and may be generally inexpensive to maintain and produce. It is noted that the reagents noted in FIG. 1 are exemplary and fluid assay preparation system 50 is not necessarily so limited.

As further shown in FIGS. 1 and 2, fluid assay preparation system 50 additionally includes reaction apparatus 60. In general, reaction apparatus 60 may be configured to process a fluid sample into a desired assay and specifically includes process vessel 67 as a location for performing the one or more reactions. As noted above, fluid assay preparation 50 may be configured to be reusable and, more specifically, reaction apparatus 60 may be configured to be reusable. Specific configurations of reaction apparatus 60 for facilitating its reuse are described in detail below in reference to FIG. 3. In some embodiments, fluid assay preparation system 50 may include a sonication system for introducing high frequency sounds waves in proximity to process vessel 67. The incorporation of a sonication system may be particularly applicable in cases in which cell lysing is desired for the preparation of a fluid assay.

In addition, fluid assay preparation system 50 includes an assembly of one or more pumps, one or more valves, and control electronics interposed between reaction apparatus 60 and reagent pack 56/reagent pack receiver 64. In particular, reagent pack receiver 64 may be coupled to multi-port valve 58, which in turn may be coupled to reaction apparatus 60 by fluidic lines. (It is noted that fluidic lines coupled between reaction apparatus 60 and multiport valve 58 are not shown in FIG. 2 to simplify the drawing, particularly given the small size of reaction apparatus 60 relative to other components of fluid assay preparation system 50.) In addition, input 52 may be coupled to multi-port valve 58. In an alternative embodiment, fluid assay preparation system 50 may include one or more individual valves respectively coupled to the vessels of reagent pack 56 and/or input 52. In either case, fluid assay preparation system 50 may further include control electronics 66 and pump system 62 (including one or more pumps). In general, control electronics 66, pump system 62 and the one or more valves of the system may be collectively configured such that the sample introduced within input 52 and the reagents within reagent pack 56 may be introduced into process vessel 67 as well as drawn therefrom, preferably at separate stages within the fluid assay preparation process. A more detailed description of exemplary routings of the reagents to and from reaction apparatus 60 is provided in reference to FIGS. 7-10 below.

As shown in FIG. 2, fluid assay preparation system 50 may include storage medium 68 coupled to control electronics 66. In general, storage medium 46 may include program instructions which are executable by a processor for automating the preparation of a fluid assay, such as but not limited to the steps described in below in reference to the flowcharts depicted in FIGS. 7-10. It is noted that storage medium 68 is shown coupled to control electronics 66 by dotted lines in FIG. 2 to indicate that that the connection may be either fixed or detachable. Storage medium 68 may include but is not limited to a read-only memory, a random access memory, a magnetic or optical disk, or a magnetic tape. The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), or other technologies or methodologies, as desired.

In some embodiments, storage medium 68 may include a processor for executing the program instructions. In other embodiments, however, storage medium 68 may be configured to be coupled to a processor (e.g., by a transmission medium). In either case, the processor may take various forms, including a personal computer system, mainframe computer system, workstation, network appliance, Internet appliance, personal digital assistant (PDA), a digital signal processor (DSP), field programmable gate array (FPGA), or other device. In general, the term “computer system” may be broadly defined to encompass any device having one or more processors, which executes instructions from a memory medium.

An exemplary configuration of reaction apparatus 60 is shown in FIG. 3. As shown in FIG. 3, reaction apparatus 60 may include injection/aspiration line 61 which may be used to receive and dispatch solutions to and from process vessel 67, such as from/to reagent pack 56 and input 52 of fluid assay preparation system 50. In particular, injection/aspiration line 61 may be coupled to the fluidic lines routed from/to reagent pack 56 and input 52. Reaction apparatus 60 further includes analysis module aspiration line 63, which may be used to dispatch solutions within process vessel 67 to an analysis module that may or may not be part of fluid assay preparation system 50. In an alternative embodiment, reaction apparatus 60 may be configured to analyze a solution residing within process vessel 67. In any case, reaction apparatus 60 may include vent port 65 as shown in FIG. 3.

In some embodiments, surfaces of injection/aspiration line 61, analysis module aspiration line 63, and vent port 65 as wells as interior surfaces of process vessel 67 may include a material having a coefficient of friction less than or equal to approximately 0.1 relative to polished steel. In particular, materials with such a low coefficient of friction may generally be advantageous for inhibiting the adherence of solutions (i.e., a fluid sample and/or any reagents used to process a sample). Consequently, the amount of residual solution remaining in process vessel 67 and in lines 61, 63 and 65 after a sample is removed may be reduced. As a result, decontamination of process vessel 67 and lines 61, 63 and 65 may be easier and the reuse of reaction apparatus 60 for preparation of other fluid assays may be more feasible. In addition to their interior surfaces, the exterior surfaces of injection/aspiration line 61, analysis module aspiration line 63 and vent port 65, at least along the portions of the lines disposed within process vessel 67, may include such a material. Exemplary materials having a coefficient of friction less than or equal to approximately 0.1 relative to polished steel include but are not limited to polytetrafluorethylene (PTFE), perfluoroalkoxy polymer resin (PFA) and fluorinated ethylene-propylene (FEP), each of which is commercially available as Teflon™ from DuPont Company.

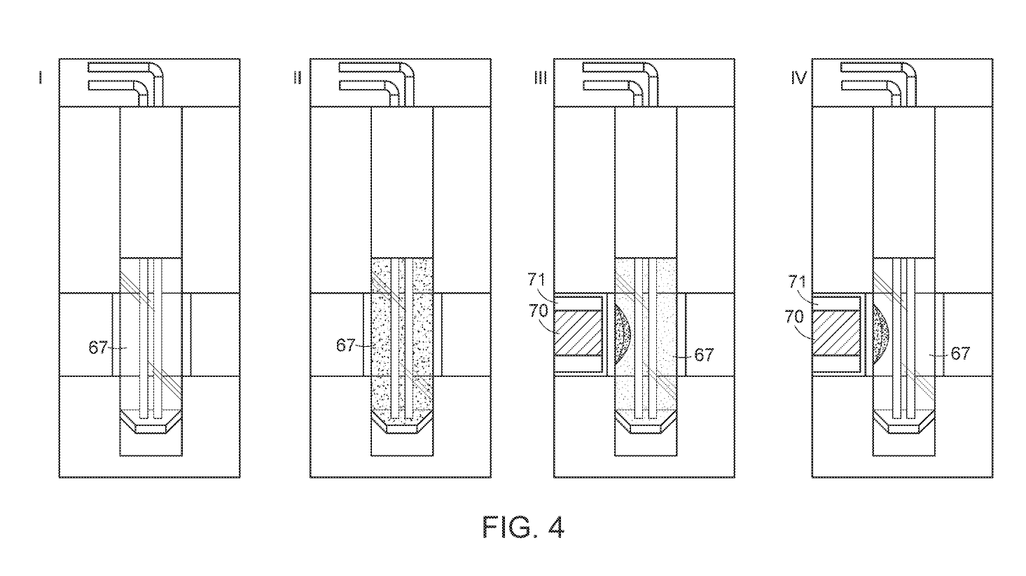

Further to reducing the amount of residual solution in process vessel 67 after a sample is removed, injection/aspiration line 61 and analysis module aspiration line 63 may, in some embodiments, extend into process vessel 67 a distance less than approximately 1.0 mm from the bottommost surface of the process vessel floor. In particular cases, injection/aspiration line 61 and/or analysis module aspiration line 63 may extend into process vessel 67 a distance less than approximately 0.5 mm from the bottommost surface of the process vessel floor. Such configurations may facilitate maximum removal of solution from process vessel 67. As a result, decontamination of process vessel 67 may be easier and the reuse of reaction apparatus 60 for preparation of other fluid assays may be more feasible. To further facilitate the maximum removal of solution from process vessel 67 and further realize the aforementioned benefits, process vessel 67 may include a tapered floor. For example, as shown in FIGS. 1 and 4, process vessel 67 may include a floor having chamfered sidewalls relative to the bottommost surface of the vessel.

As further shown in FIG. 3, reaction apparatus 60 may include magnet actuator 71 and magnet 70. An exemplary manner in which to utilize magnet actuator 71 and magnet 70 for preparing a fluid assay is shown in FIG. 4. In particular, FIG. 4 includes snapshot I in which process vessel 67 is empty and, therefore, no fluid sample or reagent has been introduced therein. FIG. 4 further illustrates snapshot II in which process vessel 67 is filled with a fluid sample, magnetic microspheres and, in some cases, one or more reagents. Snapshot III of FIG. 4 illustrates magnet 70 actuated in proximity to process vessel 67 to immobilize the magnetic microspheres and snapshot IV of FIG. 4 illustrates process vessel 67 having the fluid removed when the magnetic microspheres are immobilized. A more detailed description of possible stagings of such an operation during a fluid assay preparation procedure is provided below in reference to FIGS. 7-10.

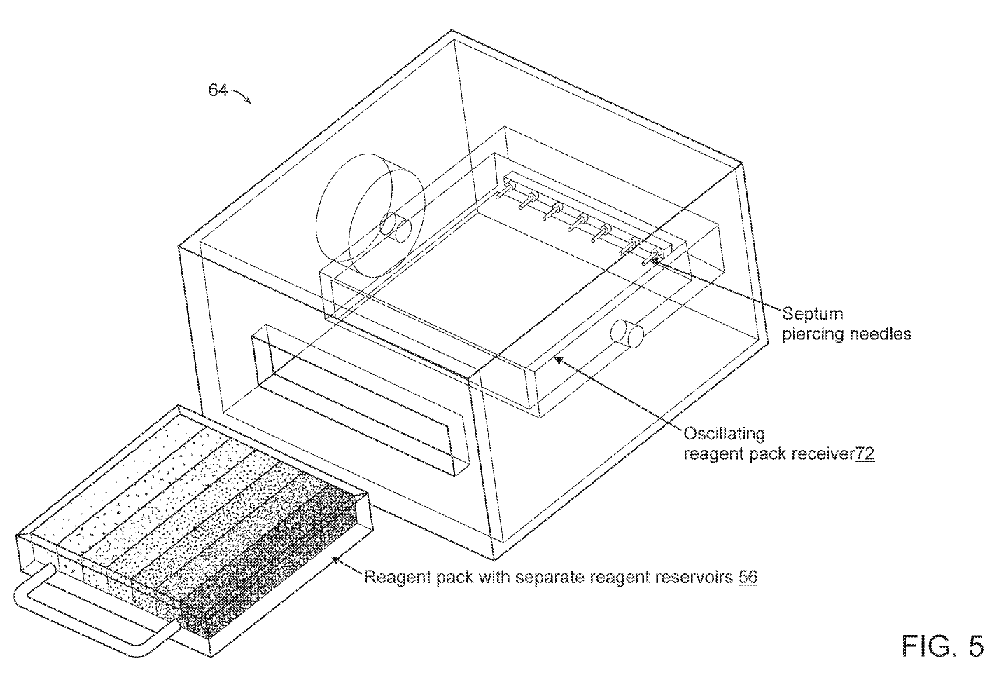

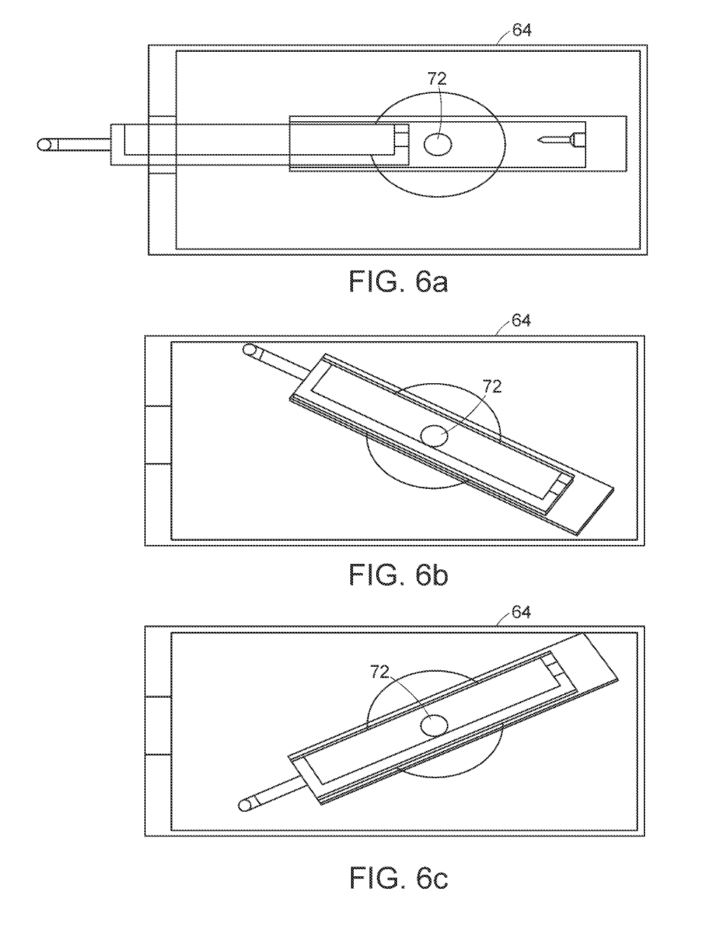

FIG. 5 illustrates an exemplary configuration for reagent pack receiver 64. In particular, FIG. 5 illustrates reagent pack receiver 64 including a slot to receive reagent pack 56. As shown in FIG. 5, the slot may include septum piercing needles to puncture vessels of reagent pack 56 and allow the reagents to be routed to a multi-port valve 58 and/or any valve respectively coupled thereto. The slot and piercing needles allow for easy removal and installation while not requiring the operator to make the fluidic connections. In some embodiments, it may be advantageous to configure reagent pack receiver 64 to oscillate. In particular, it may be advantageous, in some embodiments, to agitate one or more reagents within reagent pack 56. For example, it may be advantageous to agitate microspheres in solution to reduce clumping in a reagent pack vessel. Such agitation may be incorporated within reagent pack receiver 64 by tilting mechanism 72, various positions of which are illustrated in cross-sectional views of reagent pack receiver 64 in FIGS. 6a-6c. In some embodiments, reagent pack 56 may include a small air bubble within one or more of the reagent vessels to main suspension of components within the respective reagents during oscillation of tilting mechanism 72. The presence of an air bubble may be particularly advantageous for reagents comprising microspheres to maintain their suspension within the accompanying slurry. In general, the operation of titling mechanism 72 may be continuous, periodic, or sporadic.

Turning to FIGS. 7-10, flowcharts of exemplary methods for preparing fluid assays are shown. As noted above, the storage medium 68 of the fluid assay preparation system 50 may include program instructions which are executable by a processor for automating the preparation of a fluid assay, such as but not limited to the steps described below in reference to the flowcharts depicted in FIGS. 7-10. Therefore, the methods described in reference to FIGS. 7-10 may be referred to as “computer-implemented methods.” It is noted that the terms “method” and “computer-implements method” may be used interchangeably herein. It is also noted that the computer-implemented methods and program instructions of the systems described herein may, in some cases, be configured to perform processes other than those associated with fluid assay preparation and, therefore, the computer-implemented methods and program instructions of systems described herein are not necessarily limited to the depiction of FIGS. 7-10.

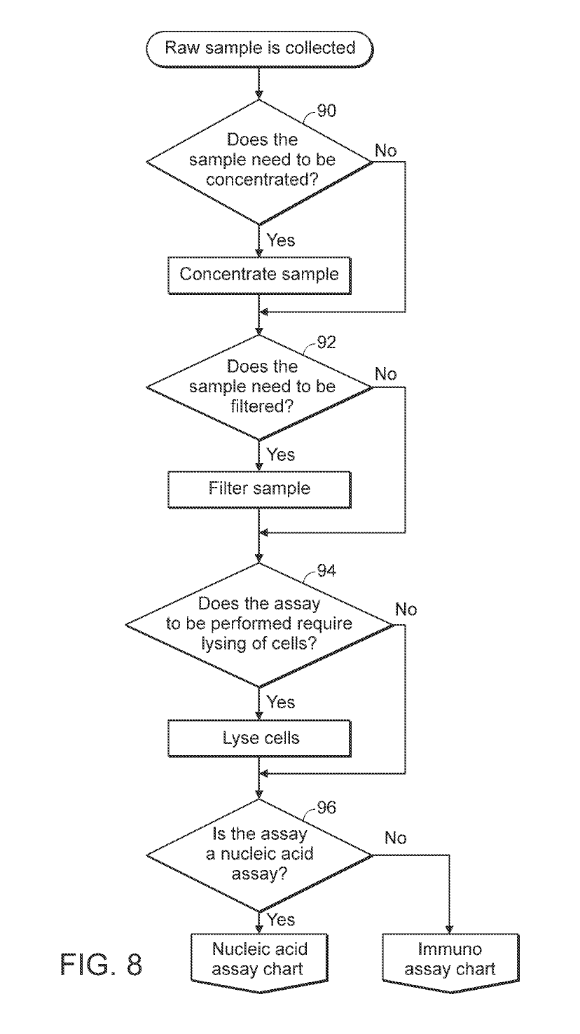

As shown in FIG. 7, a method for preparing a fluid assay may include block 80 in which a fluid sample is mixed with a first set of magnetic microspheres. In reference to fluid assay preparation system 50, the process of block 80 may include infusing a fluid sample into input 52 and routing the fluid through multi-port valve 58 to process vessel 67. Subsequent or concurrent thereto, a first set of magnetic microspheres from reagent pack 56 may be routed to through multi-port valve 58 to process vessel 67 to mix with the fluid sample. In some embodiments, the fluid sample may be preprocessed (i.e. processed prior to being introduced into the system) such as by the processing steps described below in reference to FIG. 8. In addition or alternatively, the state of the sample may be transformed prior to being introduced into the system. For example, a solid sample, such as biological tissue, may be suspended within a buffer or an air sample may be condensed into a liquid. In other embodiments, the fluid sample may not be processed prior to being introduced into the system. In such cases, the system may, in some embodiments, be configured to conduct some of the steps described below in reference to FIG. 8. For example, input 52 may, in some cases, include a filter. In addition or alternatively, reagent pack 56 may include a lysing agent for lysing cells within the fluid sample. In such cases, it may be particularly advantageous for the systems to include a sonication system to insure the cells are lysed after a certain incubation time.

It is noted that other reagents which are known for processing a fluid sample may be additionally or alternatively stored within reagent pack 56 for mixing with the magnetic microspheres and the fluid sample during block 80, such as but not limited to those specific to processing tissue or fluid samples. Consequently, the methods and the systems described herein are not necessarily restricted to the aforementioned processes. In any case, incorporating the aforementioned process steps into the systems can expand the functionality of the systems to perform two processes: the automation of sample processing and the automation of assay preparation. Sample processing is the conversion of a raw sample into a form that is compatible with the desired assay. Assay preparation takes the converted sample and forms a microsphere based assay.

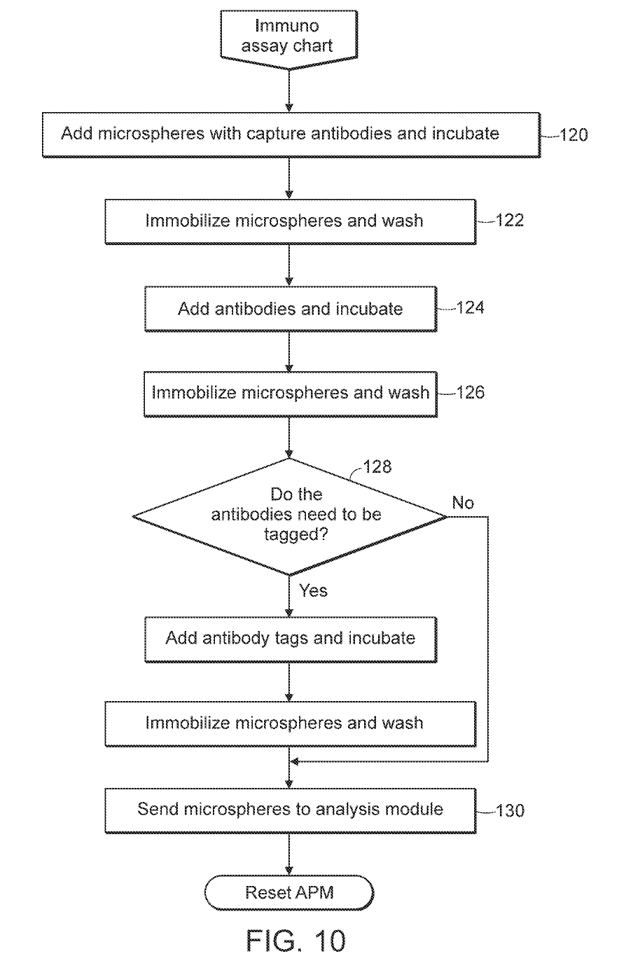

In general, the first set of magnetic microspheres referenced for mixing with the fluid sample in block 80 may be configured to react with the fluid sample to capture a desired agent upon the magnetic microspheres. For example, in some cases, the first set of magnetic microspheres may be configured to capture nucleic acid from a fluid sample. Such a process is illustrated in the nucleic acid assay flowchart depicted in FIG. 9 and is described in more detail below. Alternatively, the first set of magnetic microspheres may be configured to capture antigens located in a biological sample (such as tissue or bodily fluid). Such a process is illustrated in the immunoassay flowchart depicted in FIG. 10 and is described in more detail below.

The term “microparticle” is used herein to generally refer to particles, microspheres, polystyrene beads, quantum dots, nanodots, nanoparticles, nanoshells, beads, microbeads, latex particles, latex beads, fluorescent beads, fluorescent particles, colored particles, colored beads, tissue, cells, micro-organisms, organic matter, non-organic matter, or any other discrete substrates or substances known in the art. Any of such terms may be used interchangeably herein. Exemplary magnetic microspheres which may be used for the methods and systems described herein include xMAP® microspheres, which may be obtained commercially from Luminex Corporation of Austin, Tex. It is noted that magnetic microspheres are referenced herein as reagents and, therefore, may constitute a reagent which reagent pack 56 may be configured to store for the preparation of a fluid assay. More specifically, the term “reagent” as used herein may generally be referred to herein as a substance used to prepare a product.

Subsequent to a predetermined incubation time (which may be assay-specific) for the process described in block 80, the method may continue to block 81 in which the first set of magnetic microspheres are immobilized with a magnetic field. Such a process may include moving magnet actuator 71 such that one or more magnets of fluid assay preparation system 50 are in proximity to reaction apparatus 60. Subsequent thereto, the method may continue to block 82 in which the fluid is separated from the first set of magnetic microspheres. In particular, fluid assay preparation system 50 may be operated to remove unreacted fluid sample from process vessel 67. In some embodiments, the method may continue mixing different fluid reagents with the first set of magnetic microspheres subsequent to the separation of the magnetic microspheres from the fluid sample as shown in block 84. In such cases, after mixing with the magnetic microspheres, the method may reiterate the steps of immobilizing the magnetic microspheres to separate the different fluid reagents therefrom. For example, in some cases, a washing solution may be mixed with the first set of magnetic microspheres to remove any unreacted components of the fluid sample previously mixed with the magnetic microspheres. In addition or alternatively, other reagents may be mixed with the first set of magnetic microspheres to remove components desirable for analysis, such as for example nucleic acid for nucleic acid assays. In other embodiments, reagents may be mixed with the first set of magnetic microspheres to add components to the magnetic microspheres for subsequent analysis, such as for immunoassays, for example.

In either case, the first set of magnetic microspheres may, in some embodiments, be analyzed as shown by the path between blocks 82 and 89. In reference to fluid assay preparation system 50, the process of block 89 may, in some embodiments, include moving the first set of magnetic microspheres to an analysis module, which may be part of or distinct from system 50. Such a separate analysis module may include a flow cytometry system or may include an illumination imaging system. In other cases, block 89 may include immobilizing magnetic microspheres within reaction apparatus 60 and analyzing them therein using an illumination imaging system, which may or may not be part of system 50.

In other embodiments, the method may alternatively mix the solution separated from the first set of magnetic microspheres (discussed in reference to block 82) with a second distinct set of magnetic microspheres as shown in block 86 of the flowchart depicted in FIG. 7. For example, in some embodiments, nucleic acid separated from the first set of magnetic microspheres (as described in reference to block 82) may be mixed with a reagents for performing polymerase chain reaction (PCR), which is described in more detail below in reference to FIG. 9. In such cases, it may be necessary to route fluid separated from a first set of magnetic microspheres to a temporary storage vessel within reagent pack 56 and subsequently remove the first set of magnetic microspheres from process vessel 67 prior to the process of mixing the fluid with a second distinct set of magnetic microspheres set forth in block 86. Thereafter, the fluid residing within the temporary storage vessel of reagent pack 56 may be routed back to process vessel 67 to be mixed with the second set of magnetic microspheres.

Subsequent to mixing with the second set of magnetic microspheres, the method may continue to block 87 in which the fluid is separated from the second set of magnetic microspheres. As described for the process of block 82, the process of block 87 may include the immobilization of the second set of magnetic microspheres and the removal of the residual fluid from process vessel 67. Subsequent thereto, the second set of magnetic microspheres may be analyzed as shown by the path between blocks 82 and 89. Procedures for analyzing the second set of magnetic microspheres may be generally within the scope described for analyzing the first set of magnetic microspheres and is not reiterated for the sake of brevity.

As noted above, FIG. 8 illustrates a flowchart of exemplary steps that may be used to process a fluid sample, either prior to or subsequent to being introduced into fluid assay preparation system 50. In particular, FIG. 8 outlines considerations as to how a fluid sample is processed. For example, the flow chart includes block 90 in which a determination of whether the collected sample needs to be concentrated. Examples of embodiments in which a sample may need to be concentrated is when the sample volume needs to be reduced and/or the concentration of analyte within the sample is expected to be too low. FIG. 8 further includes block 92 in which a determination of whether the collected sample needs to be filtered. A filtering process may be advantageous for removing particles which are not of interest or may interfere with the analysis of the sample. In addition to such processes, FIG. 8 includes block 94 in which a determination of whether the assay to be prepared needs the cells of the collected sample to be lysed such that material within a cell can be accessed for analysis. As described above in reference to FIG. 7, the lysing process may be performed prior or subsequent to mixing a fluid sample with a set of magnetic microspheres. Following the determinations of blocks 90, 92, and 94, the flow chart includes block 96 in which a determination of what type of assay is to be performed. The flowchart depicted in FIG. 8 outlines that a nucleic acid assay or an immunoassay (protein based) may be prepared. Flowcharts outlining exemplary methods for both types of assays are depicted in FIGS. 9 and 10, respectively, and are described in more detail below.

As shown in block 100 in FIG. 9, preparation of a nucleic assay may include capturing nucleic acid on to a carrier, such as a magnetic microsphere, which is or can be immobilized. Thereafter, the nucleic acid carrier may be immobilized and the remaining sample discarded as shown in block 102. In some cases, the nucleic acid carriers may be washed after discarding the sample. Although such a process is not depicted in FIG. 9, it is not necessarily omitted therefrom. In blocks 104 and 106, a determination of whether the nucleic acid needs to be separated from the carrier is made and, if applicable, the nucleic acid is separated therefrom. In such cases, the solution may also be heated to remove the nucleic acid from the microspheres and, consequently, fluid assay preparation system 50 may, in some embodiments, include auxiliary heaters. The processes for blocks 100, 102, 104, and 106 may generally be performed by fluid assay preparation system 50 as described above in reference to process vessel 67. After blocks 104 and 106, the method continues to blocks 108 and 110 in which a determination of whether a reverse transcription to convert RNA to DNA needs to be conducted and, if applicable, is performed in block 110.

Thereafter, a determination of whether real time monitoring (analysis) is to be performed with DNA amplification as outlined in block 112. If the determination is to go forward with real time monitoring, a PCR process is performed with a PCR solution which may be provided by Luminex Corporation of Austin, Tex. The PCR process is outlined in block 114 and is formed concurrently with plurality of steps 116 for amplifying DNA, introducing reporter tags (e.g., PE) onto the microspheres, and analyzing the microspheres. If a determination is made to forego real time monitoring, the PCR process is performed prior to the plurality of steps 116 and when the microspheres are ready for analysis, they are analyzed. In either case, analysis results may be displayed as shown in block 119. In general, the aforementioned RNA to DNA reverse transcription process, the PCR process, and plurality of steps 116 may be performed by fluid assay preparation system 50 as described above in reference to process vessel 67. In addition, the analysis process may be performed within system 50 or may be transferred to a separate analysis module. In either case, the method may continue to block 118 to reset the fluid assay preparation system/module (APM) for a new sample.

FIG. 10 illustrates a flowchart of an exemplary process for preparing an immunoassay. As shown in FIG. 10, the method may include block 120 in which a fluid sample is mixed with magnetic microspheres having antibodies attached thereto. After an assay-specific incubation period, the magnetic microspheres are immobilized and washed as noted in block 122 and subsequently additional antibodies are added to the magnetic microspheres as noted in block 124. Subsequent thereto, the method continues to block 126 in which the magnetic microspheres are immobilized and washed again. A determination as to whether the antibodies need to be tagged is shown in block 128 followed by the appropriate steps if applicable. Thereafter, the microspheres are sent to an analysis module as shown in block 130. In general, each of the process steps leading up to block 130 (i.e., blocks 120, 122, 124, 126, and 128) may generally be performed by fluid assay preparation system 50 as described above in reference to process vessel 67. The analysis of the magnetic microspheres referenced in block 130 may be performed within system 50 (i.e., process vessel 67) or may be transferred to a separate analysis module. In either case, the method may include resetting the fluid assay preparation system/module (APM) for a new sample after block 130.

It will be appreciated to those skilled in the art having the benefit of this disclosure that this invention is believed to provide systems and methods for preparing fluid assays. Further modifications and alternative embodiments of various aspects of the invention will be apparent to those skilled in the art in view of this description. For example, although the description of the systems and the methods described herein are thorough for the preparation of fluid assays, the systems and the method may include additional components or steps were omitted from the diagrams for clarity of operation. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for preparing a fluid assay, comprising:
a reusable reaction apparatus comprising a process vessel with a tapered floor;
a plurality of fluidic lines coupled to the reusable reaction apparatus, wherein the plurality of fluidic lines extend into the process vessel a distance less than approximately 1.0 mm from a bottommost surface of the tapered floor;
a reagent pack receiver coupled to the process vessel via the plurality of fluidic lines, wherein the reagent pack receiver is configured to receive a plurality of reagent filled vessels; and
an assembly of one or more pumps, one or more valves, and control electronics collectively configured to separately pass reagents from the reagent filled vessels to the process vessel and further draw fluids out of the process vessel.

2. The system of claim 1, wherein the tapered floor comprises chamfered sidewalls relative to the bottommost surface.

3. The system of claim 1, wherein the plurality of fluidic lines extend into the process vessel a distance less than approximately 0.5 mm from the bottommost surface of the tapered floor.

4. The system of claim 1, wherein inner and outer surfaces of the plurality of fluidic lines and an inner surface of the process vessel comprise one or more materials having a coefficient of friction less than or equal to approximately 0.1 relative to polished steel.

5. The system of claim 1, further comprising a storage medium having program instructions which are executable by a processor for:
passing a first set of reagents from the plurality of reagent filled vessels to the process vessel for preparation of a first assay;
passing a decontamination solution from the plurality of reagent filled vessels to the process vessel subsequent to preparing of the first assay; and
passing a second set of reagents from the plurality of reagent filled vessels to the process vessel for preparation of a second assay subsequent to removing the decontamination solution from the process vessel.

6. The system of claim 5, wherein the first set of reagents are for processing a fluid sample into a form that is compatible with a predetermined assay.

7. The system of claim 6, wherein the first set of reagents are further for converting the processed sample into a microsphere based assay.

8. The system of claim 1, wherein the reusable reaction apparatus further comprises a magnet disposed on an actuating arm, wherein the control electronics and the actuating arm are collectively configured to move the magnet toward and away from the process vessel.

9. The system of claim 1, further comprising a sonication system configured to introduce high frequency sounds waves in proximity to the process vessel.

10. The system of claim 1, wherein the reagent pack receiver is configured to receive a plurality of reagent filled vessels having amounts sufficient to prepare multiple assays.

11. The system of claim 1, wherein the reagent pack receiver is configured to oscillate.

12. A storage medium having program instructions which are executable by a processor for:
transporting a first set of reagents from a plurality of reagent filled vessels to a reaction apparatus for preparation of a first assay;
transporting a decontamination solution from the plurality of reagent filled vessels to the reaction apparatus subsequent to the preparation of the first assay; and
transporting a second set of reagents from the plurality of reagent filled vessels to the reaction apparatus for preparation of a second assay subsequent to removing the decontamination solution from the reaction apparatus.

13. The storage medium of claim 12, wherein the program instructions for transporting the first set of reagents are for processing a fluid sample into a form that is compatible with a predetermined assay.

14. The storage medium of claim 13, wherein the program instructions for transporting the first set of reagents comprise program instructions for transporting different reagents of the first set of reagents at different stages.

15. The storage medium of claim 13, wherein the program instructions for transporting the second set of reagents are for processing a different fluid sample into a form that is compatible with a different predetermined assay.

16. The storage medium of claim 13, wherein the program instructions for transporting first set of reagents are further for converting the processed sample into a microsphere based assay.

17. The storage medium of claim 16, further comprising program instructions executable by the processor for analyzing the microsphere based assay.

18. The storage medium of claim 16, further comprising program instructions executable by the processor for transferring the microsphere based assay to an analysis module prior to transporting the decontamination solution from the plurality of reagent filled vessel to the reaction apparatus.

19. The storage medium of claim 12, further comprising program instructions executable by the processor for moving a magnet in proximity to the reaction apparatus while transporting at least one of the first and second sets of reagents from the plurality of reagent filled vessels to the reaction apparatus.

20. The storage medium of claim 12, further comprising program instructions executable by the processor for activating a sonication system to introduce high frequency sound saves in proximity to the reaction apparatus while transporting at least one of the first and second sets of reagents from the plurality of reagent filled vessels to the reaction apparatus.
